(19) United States
(12) Patent Application Publication
(10) Pub. No.: US 2025/0108656 A1
(43) Pub. Date: Apr. 3, 2025

(54) Marking Utensil Sharpener and Holder

(71) Applicant: C.H. HASON CO., NAPERVILLE, IL (US)

(72) Inventors: Steven Cates, Wheaton, IL (US); Wayne Zhang, Kunshan City (CN)

(21) Appl. No.: 18/376,432

(22) Filed: Oct. 3, 2023

(51) Int. Cl. B43L 23/08

(52) U.S. Cl. CPC B43L 23/08

(57) ABSTRACT

This invention relates generally to marking utensil holders and sharpeners. More specifically, the invention relates to an improved holder for such utensils and a removably attachable sharpener therefore.

### CROSS REFERENCE TO RELATED APPLICATIONS

None.

### TECHNICAL FIELD OF THE INVENTION

This invention relates generally to marking utensil holders and sharpeners. More specifically, the invention relates to an improved holder for such utensils and a removably attachable sharpener therefore.

### BACKGROUND OF THE INVENTION

Within the construction and carpentry trades, marking utensils, to include crayons, are often utilized to mark the surfaces of various construction materials, to include lumber, structural steel, concrete masonry units and similar materials. Of course, the surfaces of these materials may be rough or irregular, thus making it difficult to mark with a standard carpenter's pencil, or similar utensil utilizing a lead-based medium, due to that surface causing the marking lead to break at its tip. FIGS. 1-3 illustrate one such embodiment of a marking utensil 5 comprising a marking crayon. As illustrated therein, the marking utensil 5 typically comprises a lengthwise stick defining opposite ends 10 and 15 and an outer surface 20. The marking utensil 5 is typically comprised of a wax or clay material, or a combination thereof that is softer than the lead of a pencil such that the utensil can sufficiently mark these rough or irregular surfaces without breaking at its tip 25 (defined at one or both ends 10 and/or 15). These marking utensils 5 are typically about 11.4 cm long and define a cross-sectional hexagonal point-to-point thickness (FIG. 5) or a circular diameter (not illustrated herein) of about 12.7 mm.

Unlike the lead of a carpenter's pencil however, the wax or clay material of a marking utensil 5 is not surrounded and supported by a wood casing. Thus, because of these softer compositions and absent the wood casing, marking utensil 5 may undesirably break along their lengths when grasped by a user and pressed against a desired marking surface, or when stored in a typical clothing pocket or tool box due to the inadvertent application of a bending force within the pocket or a weighted force from an adjacent tool within the tool box. Thus, marking utensil holders, to include marking crayon holders, have been utilized within the carpentry and construction trades to removably house marking utensils 5 and protect them along their lengths.

FIGS. 4-6 illustrate one such embodiment of a marking utensil holder 30. In this embodiment, the marking utensil holder 30 comprises an axial and rigid hollow sleeve 35 defining inner and outer surfaces 40 and 45, and forward and rearward ends 50 and 55. The inner surface 40 of the sleeve 35 is about cylindrical and configured to accept the insertion of the crayon, chalk or other marking utensil there-through while the external surface 45 of the sleeve preferably defines a round cross section and is configured to be gripped in a user's hand. Referring again to FIGS. 4 and 6, the cylindrical inner surface 40 terminates in forward and rearward openings 60 and 65 defined at the respective rearward and forward ends 50 and 55. The rearward opening 65 is configured to accept an insertion of an end 10 or 15 of the marking utensil 5 there-through while the forward opening 60 is configured to both accept a protrusion of at least that end therefrom and to removably secure the utensil therein.

As best illustrated in FIGS. 5 and 6, with further regard to securing the marking utensil 5 within the holder 30, the forward end 50 and forward opening 60 of the holder together define a collet 70. In defining the collet 70, a plurality of lengthwise through kerf cuts 75 is defined within the sleeve's forward end 50; with each cut beginning at the forward opening 60 and extending rearwardly along the sleeve 35 by a predetermined distance. The plurality of kerf cuts 75, in turn, define a plurality of sleeve segments 80 extending rearwardly from the forward end 50 and terminating unitary with the sleeve 35 such that a forward end 85 of each segment may cantilever or flex radially about its unitary connection. Thus, the forward end 85 of each sleeve segment 80 may radially expand and contract about the marking utensil 5 located within the holder 30 such that inner surfaces 90 of the respective segments may interferingly contact the outer surface 20 of the marking utensil to selectively and releasably secure it within the holder's forward end 85.

As illustrated in FIGS. 7 and 8, the selective and releasable securement of the marking utensil 5 within the collet 70 is facilitated by a collet ring 95 that is operably associated with the plurality of sleeve segments 80 of the collet. Referring now to FIGS. 9-11, the collet ring 95 preferably comprises a hollow cylinder 100 defining inner and outer surfaces 105 and 110, and forward and rearward ends 115 and 120. The inner surface 105 of the ring 95 defines threads 125 for engagement with threads 130 defined on the arcuate outer surfaces 135 of the collet's sleeve segments 80 while the external surface 45 of the sleeve 35 is configured to be gripped in a user's hand. Thus, the ring 95 may be threaded on to and off of the collet 70 via a respective clockwise and counter-clockwise rotation there-about.

The clockwise or counter-clockwise rotation of the ring 95 about the collet 70 also causes arcuate inner surfaces 90 of the collet's sleeve segments 80 to cantilever or flex radially inwardly towards the marking utensil's outer surface 20 or outwardly away there-from about their respective unitary connections with the sleeve 35. Because of the unitary connections of the segments 80 with the sleeve 35, the respective inner arcuate surfaces 90 together define the about cylindrical internal sleeve surface 40 through the length of the collet 70. In a preferred embodiment, the cylindrical inner sleeve surface 40 defines a diameter that is only slightly larger than that defined by the outer surface 20 of the utensil 5. This same internal surface diameter remains about constant throughout the length of the sleeve 35, to include that portion of the length collectively defined by the arcuate collet segments 80.

Because the internal diameter defined by the collective collet segments 80 is slightly larger than that defined by the outer surface 40 of the marking utensil 5, the utensil will remain unsecured in the holder 30 until the collet ring 95 influences the plurality of segments to cantilever or flex inwardly towards the utensil's outer surface. In the embodiment of the holder 30 illustrated herein, the influence of the ring 95 against the segments 80 is accomplished via the frusto-conical shape collectively defined by the segment's respective outer surfaces 135. From the sleeve's end 50, a frustum 140 (FIG. 5) is collectively defined rearwardly by the arcuate outer surfaces 135 of the segments 80 such that the outer diameter defined by the outer surfaces at the opening is less than the outer diameter defined by the segments at their unitary connection with the remainder of the sleeve 35 (i.e., at the rearward termination of the respective kerf cuts 75).

Thus, referring again to FIGS. 5-8, when the collet ring 95 is threadedly engaged with the collet 70, a clockwise rotation of the ring will result in the ring moving rearwardly along the collet segments 80. Because the inner diameter of the collet ring 95 is constant while the outer diameter defined by the collective collet segments 80 gradually increases via the frustum 140 (FIG. 5), the rearward rotational movement of the ring along the increased diameter of the collet segments will cantilever or flex the segments inwardly towards the utensil's outer surface 40 to interferingly contact the marking utensil 5 and secure it within the holder 30.

As illustrated in FIGS. 4 and 12, the marking utensil holder 30 may optionally have a removable cap 145 that threadedly engages the holder's rearward end 55 to cover the holder's rearward opening 65 such that the rearward directed end 10 or 15 of the utensil 5, after an insertion of the utensil into the holder's rearward opening, is protected. The holder's cap 145 also prevents miscellaneous debris typically present at a construction site, such as sawdust, metal filings, concrete dust, etc., from entering the rearward opening 65 of the holder 30 and undesirably collecting about or on the marking utensil 5 within the holder's interior.

Referring now to FIGS. 13-15, the holder's cap 145 approximates closed-end hollow cylinder 147 defining an interior cylindrical surface 150 that terminates in an opening 155 at one end 160 of the cap, with the interior cylindrical surface defining interior engagement surface, preferably comprising threads 167 proximal to the cap's open end. Referring again to FIG. 4, the outer surface 45 of the holder 30 defines an exterior engagement surface, preferably comprising threads 170 proximal to the holder's rearward end 55 and the holder's rearward opening 65. The engagement between the exterior threads 170 of the holder 30 and interior threads 165 of the cap 145 thus allow the cap and holder to be threaded to one another such that the cap covers the holder's rearward opening 65. The cap 145 optionally defines a connector 175 (FIG. 13) to which a lanyard may be attached.

As is known in the art, it is desirable for marking utensils to be sharpened to a marking point at its forward end to concentrate the mark left by the utensil on the wood or other construction material surfaces. Unfortunately, however, numerous prior art marking utensil holders (to include the foregoing embodiment recited herein) fail to provide a means for sharpening the utensil. Thus, what is needed is a marking utensil sharpener that is removably attachable to a utensil holder, as well as an improved utensil holder including that can sharpener.

Moreover, even for those marking utensil sharpeners that are removably attachable to a utensil holder, disadvantages exist in the sharpener's design; resulting in a crayon being sharpened to a pointed, conical tip that is subject to undesirably cracking or fracturing upon making marking contact with a desired surface, due to the softer composition of the wax or clay materials comprising the utensil. Also, a typical prior art crayon sharpener utilizes one or more steel blades that are attached to a sharpener housing comprised of a different material (i.e., usually of plastic). However, utilizing a steel blades within a sharpener results in undesirable increased manufacturing and production cost for several reasons: 1) the per unit cost of steel generally exceeds that of plastic; 2) the blade component must be separately manufactured or outsourced at additional material cost; and 3) the blade component must be assembled with the sharpener housing utilizing costly physical labor and/or machinery.

Additionally, prior art sharpeners often utilize a blade length that is excessive such that marking crayons are sharpened to a sharp, conical point. Compounding this excessive blade length is any associated presence of a shallow sharpening angle of the blade (i.e., as referenced from an outer surface of the crayon or other utensil) such that the conical point is long and slender. Of course, such a long and slender sharp point is subject to cracking or fracturing due to the softer composition of the wax and/or clay material comprising the utensil. Thus, for marking crayons and similar utensils, a sharpener having a shorter blade length and more severe sharpening angle that creates a blunted, truncated conical or frusto-conical marking tip is deemed preferable. Furthermore, in addition to creating a fragile, sharp point, sharpeners possessing an extended blade length and shallow sharpening angle are needlessly axially long to accommodate the length and angle. Of course, if the sharpener is removably attachable to a crayon holder, an axially compact sharpener is preferred such that the holder and attached sharpener do not possess a combined excessive axial length that is too long to non-interferingly fit in a common clothing or tool belt pocket.

Also, marking crayons and similar utensils, in generally possessing a cross-sectional thickness or diameter (D) of about 12.7 mm, thus also possess a circumference (C) larger than that of a typical carpenter's pencil or writing pencil. Thus, a marking crayon or similar marking utensil generally possesses an approximate circumference of C=π(D)=π(12.7 mm)=39.9 mm. In view of typical prior art marking utensil sharpeners possessing a single blade, such sharpeners require at least 1 complete rotation of a crayon or similar utensil in relation to one another to cut and sharpen the tip. Due to the larger 39.9 mm diameter of these crayons and utensils, however, a complete at-least-one rotation per sharpening cut of the utensil is time consuming and inefficient; especially within the environment of a typical construction worksite where a marking procedure or other construction activity must be interrupted to sharpen the crayon or other marking utensil. Furthermore, when a crayon or similar utensil requires an increased removal of material during the sharpening process, i.e., when sharpening it for the first time, the foregoing at-least-one rotation per sharpening cut is compounded even further, thus requiring multiple and additional time-consuming rotations of the crayon, or other marking utensil, and sharpener in relation to one another.

Further disadvantages exist in prior art sharpeners' design; resulting in their inability to sharpen a crayon without undesirably fracturing the crayon's marking point due the sharpener's lack of post-cut support for the wax and/or clay material composition of a typical marking crayon. More specifically, a typical prior art crayon sharpeners utilize at least one angled blade that cuts into the forward end of a crayon when the sharpener and crayon are rotated in relation to one another such that the blade defines a conical or frusto-conical marking point on the crayon.

Generally circumferally adjacent to a forward side of the blade is an ejection opening defined by the sharpener through which the crayon material removed by the blade (i.e., shavings) is directed away from the marking point defined thereby. If the marking tip of the crayon is not structurally supported after a rearward side of the blade, a user may urge the crayon or other marking utensil axially forward against the one or more blades such that the blade(s) is/are driven into the utensil by an excessive depth, thus resulting in a cracking or fracturing of the utensil's tip, when the utensil and sharpener are rotated in relation to one another, instead of the desired cutting or shaving of the material there-from. Thus, one or more a circumferal frusto-conical supports is desirable to support the frusto-conical point of the crayon or other utensil created by the blade.

Thus, there is a need for a crayon sharpener, and optional crayon holder, that are removably attachable to one another. The removably attachable sharpener should sharpen a crayon or other marking utensil to a tip that will not crack or fracture when pressed against the desired marking surface. Also, the sharpener should not require the use of a steel blade, thus eliminating the need for the associated assembly of it with the sharpener's housing. And despite not utilizing a steel blade, the sharpener should be axially compact and possess a design that nonetheless sharpens a crayon or other marking utensil to have a desired, blunt marking tip. Also, the sharpener should possess a plurality of sharpening edges such that an excessive quantity of sharpening rotation is avoided. The present invention satisfies the foregoing needs and presents further advantages over the prior art as well.

### SUMMARY OF THE INVENTION

This invention relates generally to marking utensil holders and sharpeners. More specifically, the invention relates to an improved holder for such utensils and a removably attachable sharpener therefore. In one embodiment, a marking utensil sharpener comprises an axial hollow casing defining an interior surface between an open end and a closed end, and an exterior surface terminating at the open end and encompassing the closed end. The interior surface defines an interior engagement surface proximal to the open end for removable engagement with an outer engagement surface of a marking utensil holder.

The open end is configured to accept an insertion of a marking utensil therein, with the closed end defining a segmented frusto conical socket defining a plurality of supports inwardly terminating in a plurality of frusto conical support surfaces and circumferally separated from one another by a through ejection port. Each through ejection port terminates in an outer ejection opening defined within the outer surface and in an inner ejection opening defined circumferally between adjacent support surfaces, with each ejection port defining a forward end of one support and a trailing end of a circumferally adjacent support;

A cutting edge is co-planar with the forward end of each support. Each cutting edge is parallel with and extending inwardly from the support surface, with each said cutting edge unitary with each said support and configured for cutting engagement with the marking utensil. In one embodiment, the plurality of support surfaces defines an equally bisected segmented frusto conical socket. In another embodiment, the plurality of support surfaces defines an equally tripartite segmented frusto conical socket.

The cutting edge extends inwardly of the support surface by a distance of about 0.1 mm, while the interior engagement surface defines a circumferal ridge, circumferal furrow, or a thread for engagement with an exterior engagement surface of the holder. In further embodiments, the exterior surface defines a grip comprising a plurality of ridges extending between the open and closed ends. In yet another embodiment, the closed end defines a connector configured for connection with a lanyard.

### BRIEF DESCRIPTION OF THE DRAWINGS

FIG. 1 is a left perspective view of one embodiment of a marking utensil;

FIG. 2 is an elevation view of the marking utensil of FIG. 1;

FIG. 3 is an end view of the marking utensil of FIG. 1;

FIG. 4 is a left perspective view of one embodiment of a marking utensil holder;

FIG. 5 is an elevation view of the holder of FIG. 4;

FIG. 6 is a right perspective view of the holder of FIG. 4;

FIG. 7 is an elevation view of the holder of FIG. 4 having a ring engaged with the collet;

FIG. 8 is a right perspective view of the holder and ring of FIG. 7;

FIG. 9 is a left perspective view of the ring of FIGS. 7 and 8;

FIG. 10 is an elevation view of the ring of FIG. 9;

FIG. 11 is a right perspective view of the ring of FIG. 9;

FIG. 12 is an elevation view of the holder of FIG. 4 having the a cap engages with a rearward end;

FIG. 13 is a left perspective view of the cap of FIG. 12;

FIG. 14 is an elevation view of the cap of FIG. 12;

FIG. 15 is a right perspective view of the cap of FIG. 12;

FIG. 16 is a left perspective view of one embodiment of the sharpener;

FIG. 17 is an elevation view of the sharpener of FIG. 16;

FIG. 18 is a right perspective view of the sharpener of FIG. 16;

FIG. 19 is a plan view of the interior of the sharpener of FIG. 16;

FIG. 20 is a plan view of the exterior of the sharpener of FIG. 16;

FIG. 21 is an elevation view of the sharpener of FIG. 16 rotated by ninety degrees;

FIG. 22 is a sectional view of the sharpener of FIG. 21;

FIG. 23 is a plan view of the interior of the sharpener of FIG. 21; and

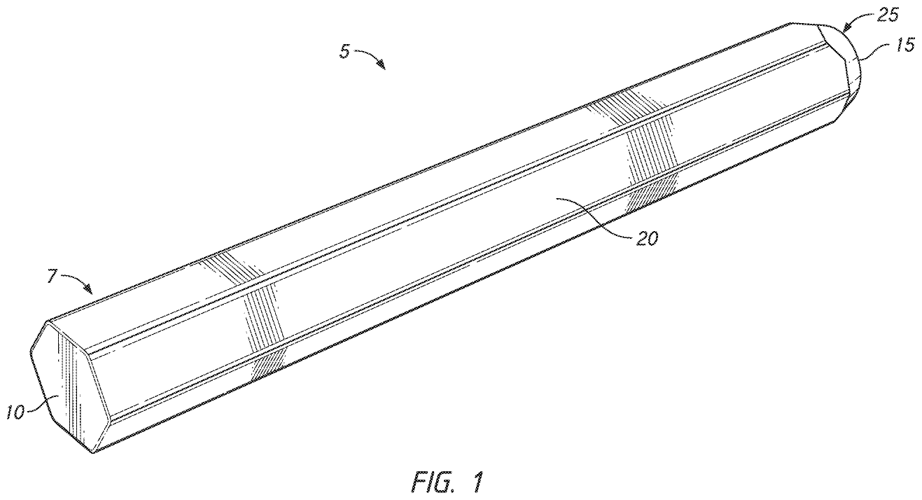

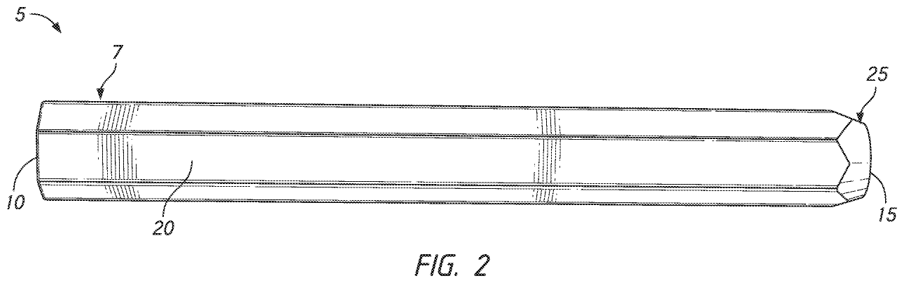

FIG. 21 is a left perspective view of the sharpener of FIG. 21.

### DESCRIPTION OF THE EMBODIMENTS

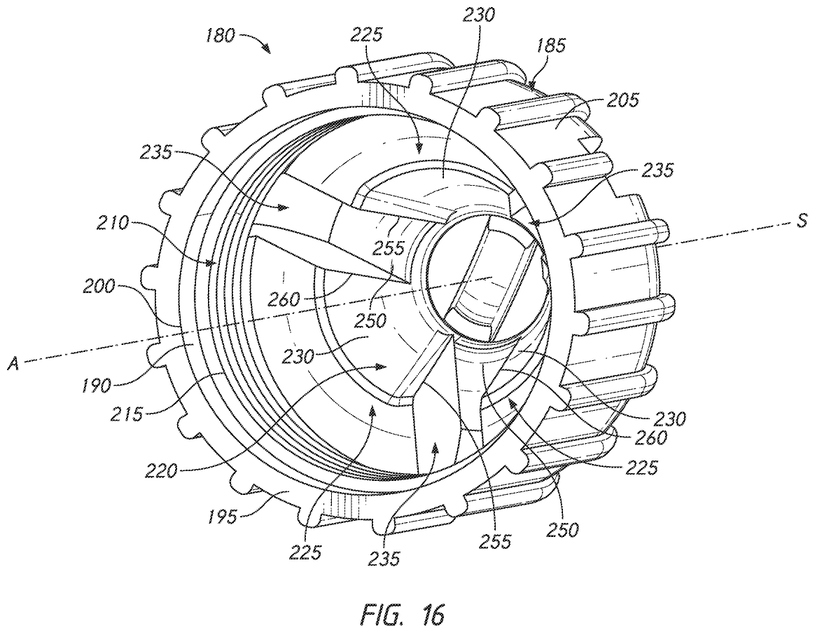

This invention relates generally to marking utensil holders and sharpeners. More specifically, the invention relates to an improved holder for such utensils and a removably attachable sharpener therefore. FIGS. 16-18 introduce one embodiment of the marking utensil sharpener 180. As illustrated therein the sharpener 180 comprises an axial hollow casing 185 defining an interior surface 190 between open and closed ends 195 and 200, and an exterior surface 205 terminating at the open end and encompassing the closed end. The interior surface 190 defines an interior engagement surface 210 proximal to the open end 195 for removable engagement with the outer engagement surface 45 of the marking utensil holder 30.

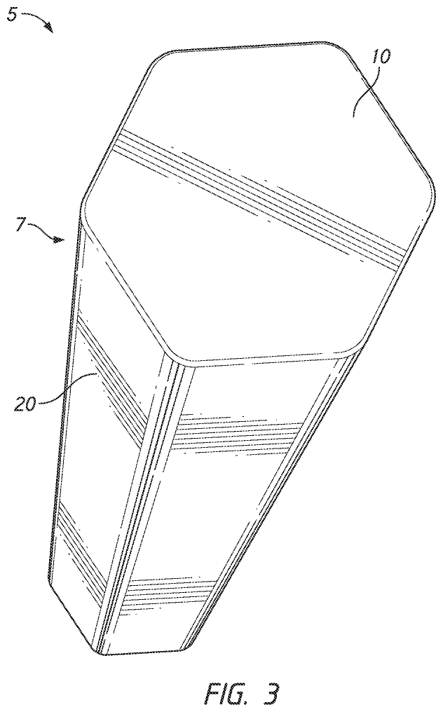

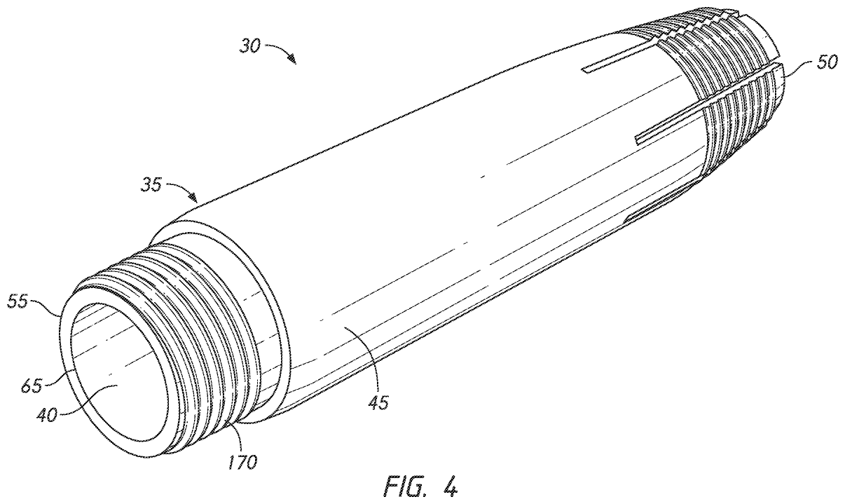

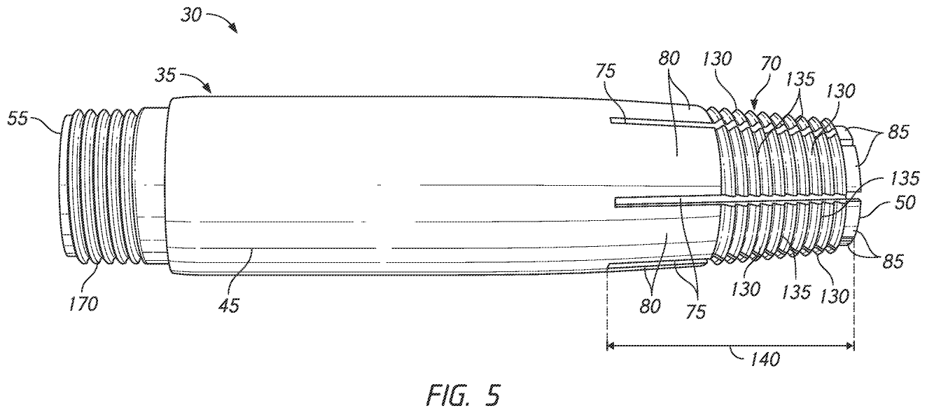

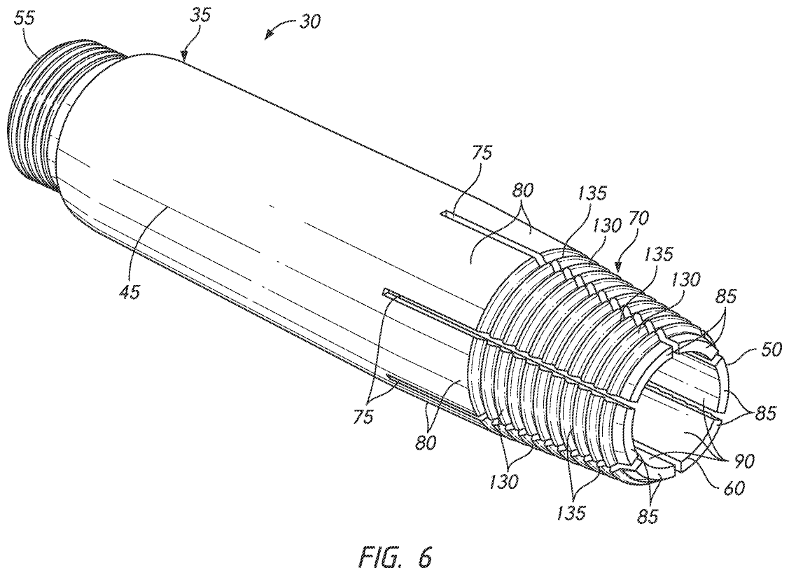

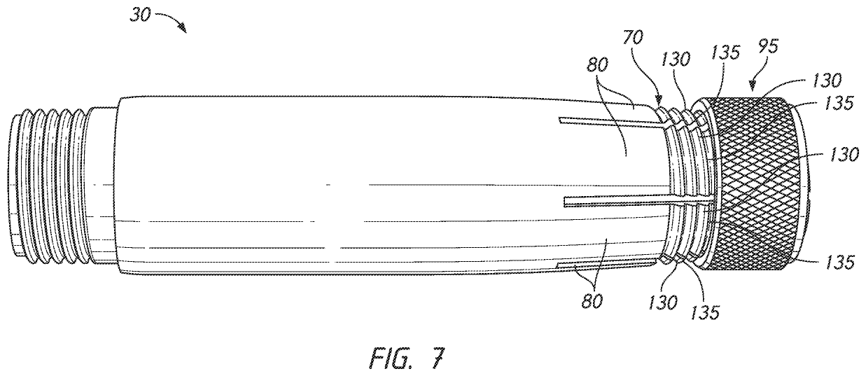

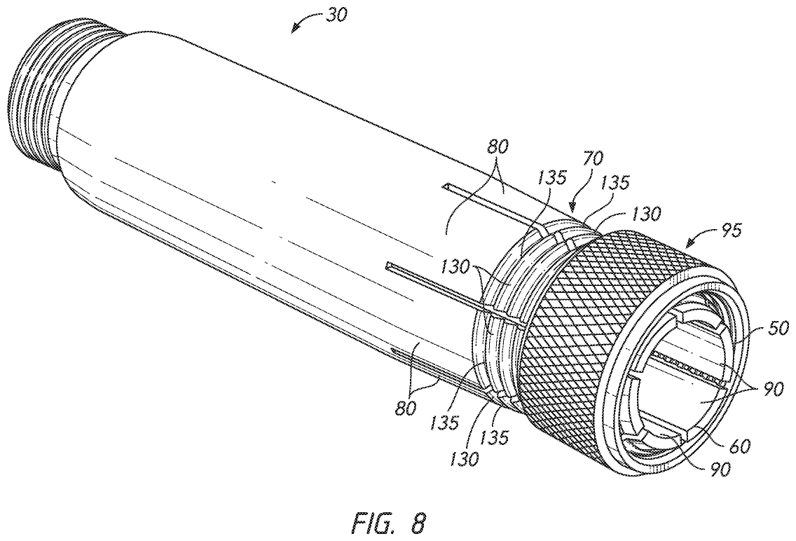

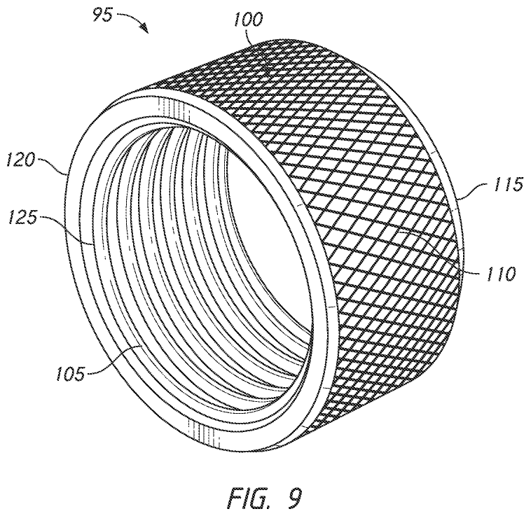

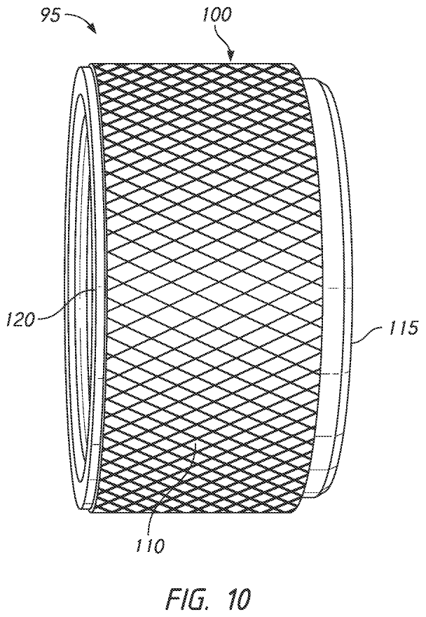

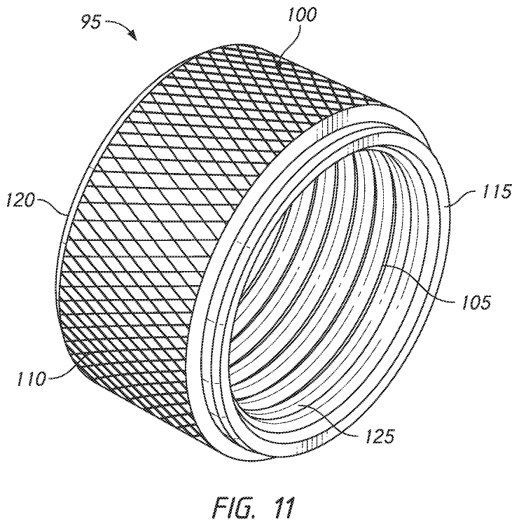

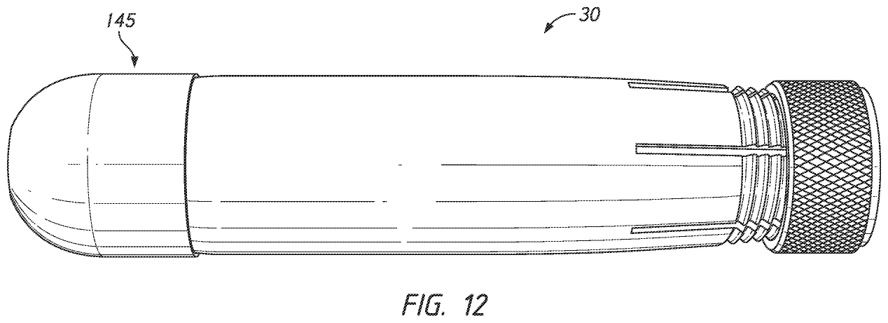

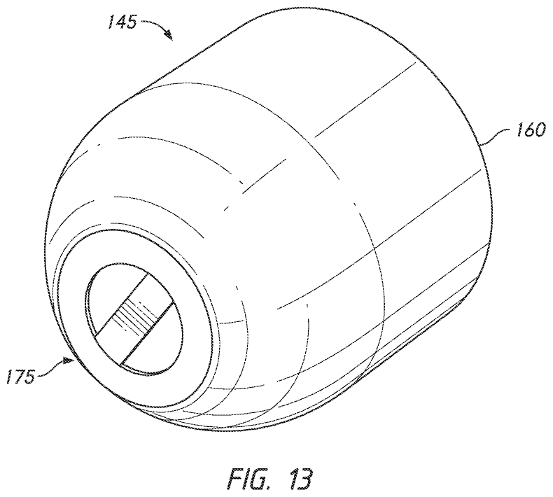

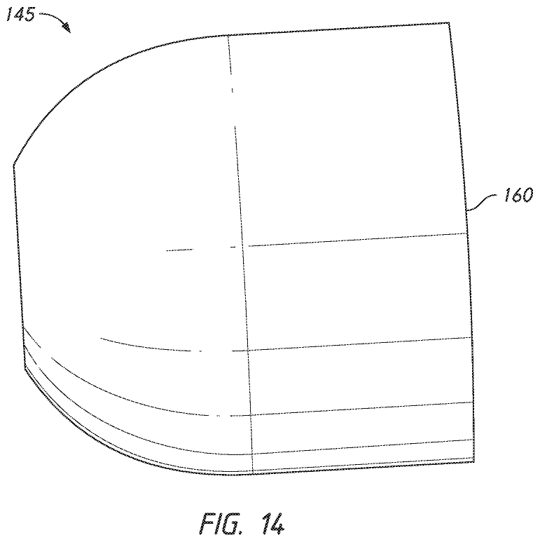

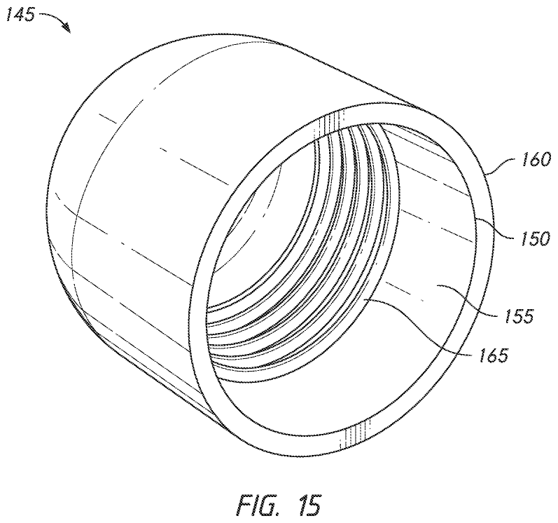

In the embodiment of FIG. 3, the interior engagement surface 210 defines a thread 215 configured for threaded engagement with the threads 170 defined in the outer surface 45 (FIG. 5) of the holder 30. In further embodiments, not illustrated herein, the engagement surface 210 defines a circumferal ridge configured for interfering engagement with a circumferal furrow defined by the outer surface 45 of the holder 30, and a circumferal furrow defined in the interior surface 190 of the sharpener 180 configured for interfering engagement with a circumferal ridge defined by the outer surface 45 of the holder.

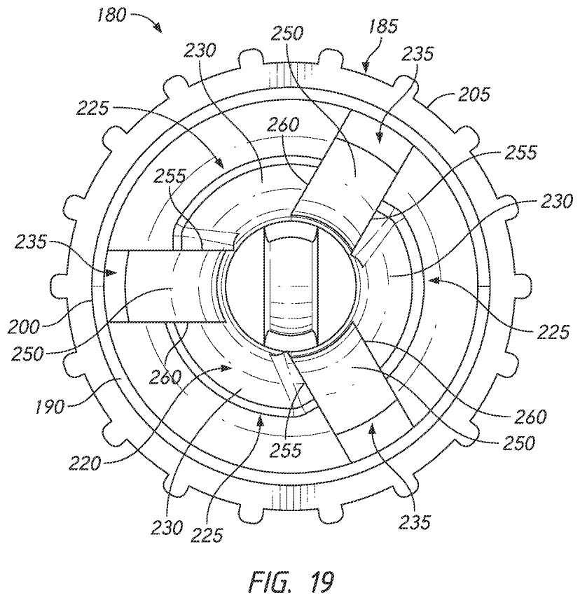

Referring again to FIG. 16, and also to FIG. 19, the open end 195 of the sharpener 180 is also configured to accept an insertion of the marking utensil 5 therein. More specifically, the open end 195 defines an opening diameter exceeding that of a marking utensil possessing a round cross section or a diametrical point-to-point distance of a marking utensil having a hexagonal cross section. Thus, to accommodate the marking utensil 5 of FIG. 3 having a point-to-point distance of about 12.7 mm, the open end 195 of the sharpener 180 preferably defines a diameter of about 22.2 mm.

Proximal to the closed end 200 of the casing 185, the interior surface 190 defines a segmented frusto conical socket 220 defining a plurality of supports 225 inwardly terminating in a plurality of frusto conical support surfaces 230 circumferally separated from one another by a through ejection port 235. These support surfaces 230 provide abutting support to the outer frusto conical surface 240 defined at the tip 25 of the marking utensil 5 during the sharpening procedure such that a user cannot urge the utensil axially forward against the cutting edges (to be further discussed) of the sharpener 180 by an excessive depth, thus preventing a cracking or fracturing of the utensil's tip when the utensil and sharpener are rotated in relation to one another.

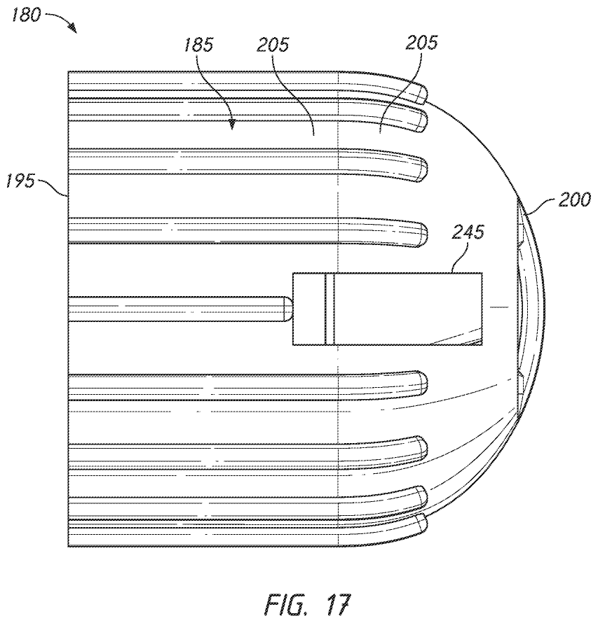

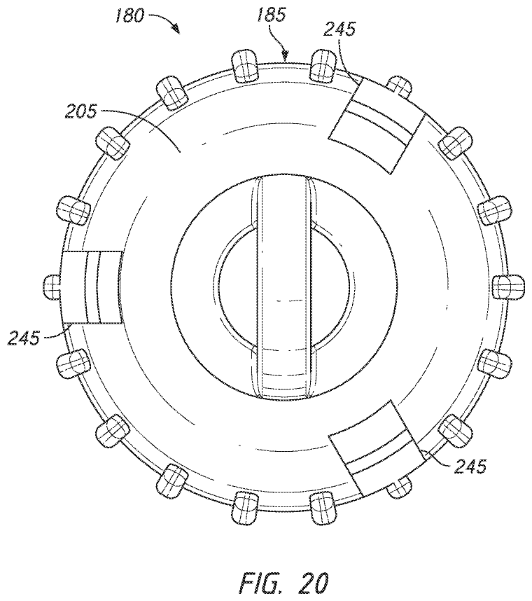

Each through ejection port 235 terminates in an outer ejection opening 250 defined within the outer surface 205 of the casing 185 (FIGS. 17, 18 and 20) and in an inner ejection opening 250 circumferally between adjacent supports 225 (FIGS. 16 and 19). Each inner ejection opening 250 defines a forward end 255 of one support 225 and a trailing end 260 of a circumferally adjacent support as referenced about an imaginary axis (AS) extending through the sharpener (FIG. 24). Each ejection port 235 directs shaving or cuttings, removed from the marking utensil 5 by a cutting edge associated with each support 225, from an interior 265 of the sharpener to a location outside the sharpener's exterior surface 205.

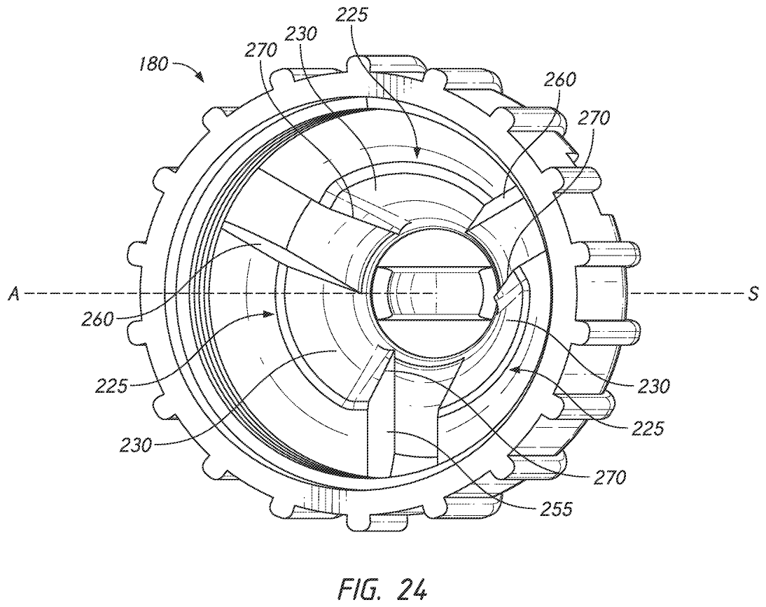

Referring now to FIGS. 21-24, each cutting edge 270 is co-planar with the forward end 255 of each support 225 and is parallel with and extends inwardly from each support surface 230, with each said cutting edge configured for cutting engagement with the marking utensil 5. To avoid the aforementioned additional costs associated with the utilization of steel blades, each cutting edge 270 is unitary with each support 225, and each support is preferably unitary with the hollow casing 185. Thus, the cutting edges 270, supports 225 and casing 185 are preferably comprised of a common material, such as high strength plastics, thermoplast materials or aluminum, such that the sharpener, to preferably include the casing, supports, and cutting edges, may be efficiently manufactured via a molding or 3-d printing process without the need for costly manual labor or machine-assisted assembly procedures. In a preferred embodiment, each cutting edge 270 of the plurality preferably defines a cutting depth into the marking utensil 5 of about 0.1 mm. Thus, each cutting edge 270 extends inwardly from each support surface 230 preferably by a distance of about 0.1 mm.

Utilizing the aforementioned 0.1 mm cutting depth, one or more shavings of the marking utensil material removed by the cutting edge 270 is/are generated as the utensil 5 and sharpener 180 are rotated in relation to one another such that a circumferally forward side ## of the cutting edge 270 cuts into the outer surface 20 of the utensil. Of course, the one or more shavings of removed material is/are directed into the inner ejection opening 250 of the ejection port 235 circumferally preceding the cutting edge 270, with the ejection port thereafter guiding the one or more shaving away from the cutting edge, outwardly though the port, and out through the port's outer ejection opening 245 defined within the sharpener's outer surface 205. Through a design and testing of sharpeners 180 with marking utensils 5 comprised of wax and/or clay materials, it was determined that each ejection port 235 and associated inner and outer ejection openings 250 and 245 should have a minimum width of about 4.0 mm to ensure an unencumbered transition of the one or more shavings there-through and out of the port's outer ejection opening, thus preventing the port from becoming undesirably clogged with the shavings.

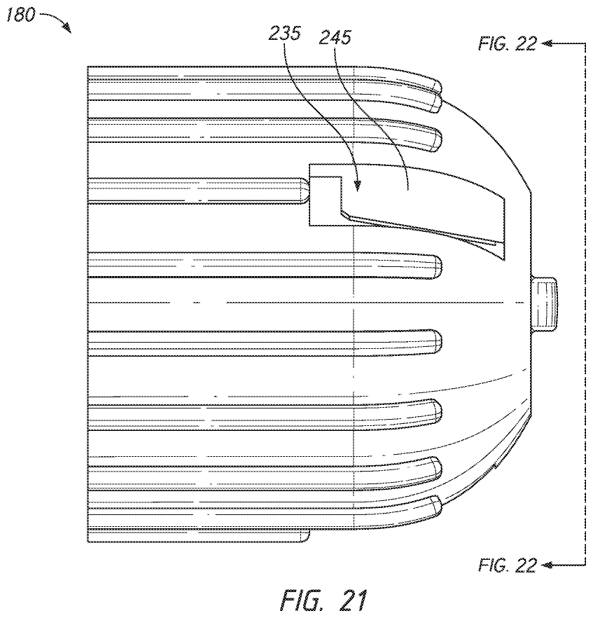

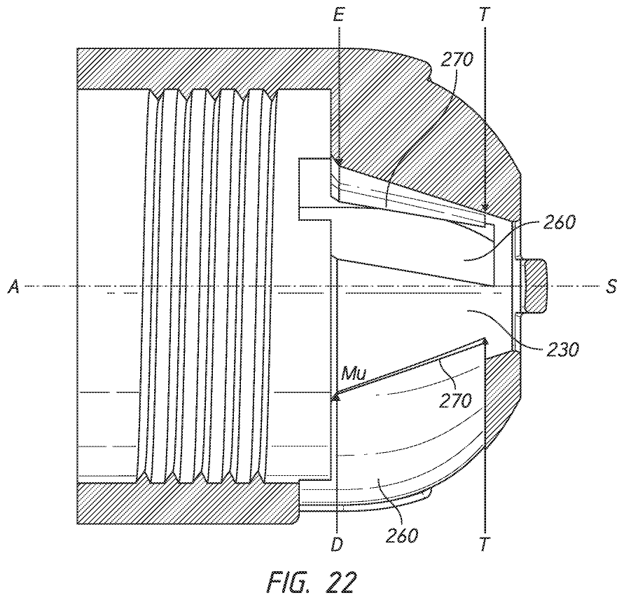

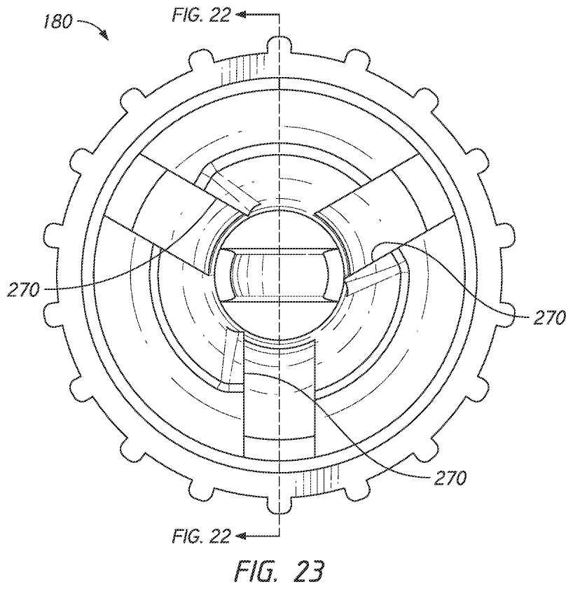

In avoiding the aforementioned cracking or fracturing of conically-pointed marking utensil tips, a blunted, truncated conical or frusto-conical marking tip is deemed preferable, with the blunted or frusto-conical end nonetheless defining a marking tip concentrated enough to leave a concise mark, but blunted enough to avoid the aforementioned cracking or fracturing. Referring again to FIGS. 21, 22 and 24, through a design and testing of sharpeners 180 conducted with the hexagonal marking utensil of FIG. 3 having an approximate 12.7 mm point-to-point diametrical distance, it has been determined that each cutting edge 270 of the plurality should preferably define a cutting length (CL) of about 10.9 mm, while each cutting edge and associated support surface 230 define an angle (μ) of about 71 degrees (as measured from a radial line perpendicular to the imaginary axis (AS) of the sharpener 180; FIG. 22) such that the frusto-conical socket defines an entrance diameter (ED) of about 13.3 mm and a terminal diameter (TD) of about 7.3 mm. The foregoing preferred specifications thus create a blunted, truncated conical or frusto-conical marking tip 25 having a frustum axial length (AL) of about 12.7 mm and an angle theta (θ) of about 71 degrees (as measured from a radial line perpendicular to an imaginary axis of the marking utensil) such that the forward end of the frustum defines a diameter (D) of about 7.3 mm. The foregoing specifications also result in a sharpener 180 of reduced axial length, thus fulfilling the need of providing a compact sharpener.

The cutting edges 270 define a plurality via their respective unitary association with the plurality of supports 225. Of course, a plurality of cutting edges 270 is desirable for the goal of reducing the number of rotations (of the marking utensil 5 and sharpener 180 in relation to one another) necessary to sharpen the marking utensil. Whereas a prior art sharpener possessing a single blade requires at least one complete rotation to remove material from the entire circumference of the marking utensil's tip, the present sharpener 180 divides that complete rotation by the number of cutting edges 270 utilized, so long as the edges define equal circumferal distances (i.e., arc lengths) between one another. In one embodiment, the plurality of support surfaces 230 defines an equally bisected segmented frusto conical socket 220, thus providing two associated cutting edges 270. In another embodiment, the plurality of support surfaces 230 defines an equally tripartite segmented frusto conical socket 220, thus providing three associated cutting edges 270. However, it is understood that the support surfaces 230 may define any quantity of equally segmented frusto conical sockets 220 and an equal number of cutting edges 270, so long as the widths of the associated ejection ports 235 do not reduce the respective widths of the supports surfaces such that the tip 25 of the marking utensil 5 is inadequately supported during rotation.

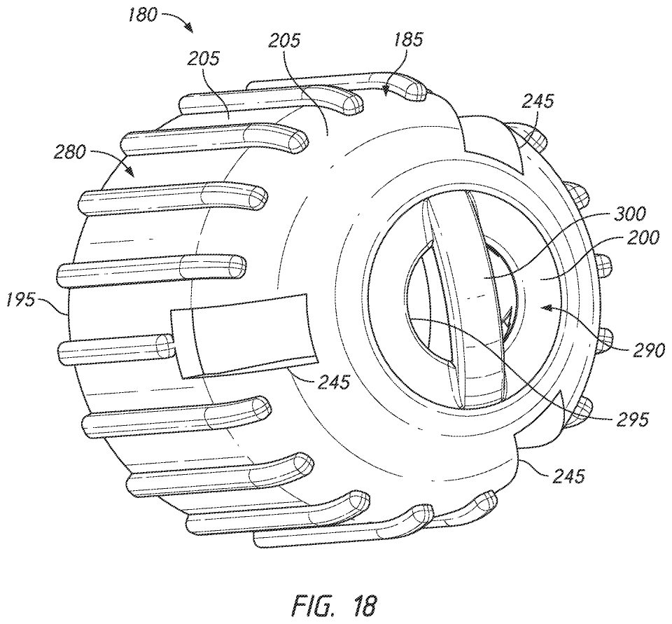

Referring again to FIG. 18, to enable one to readily grasp the sharpener 180 while rotating it and the marking utensil 5 in relation to one another, the exterior surface 205 of the casing 185 defines a grip 280 that increases the frictional contact between the user's hand and the sharpener's exterior surface. In a preferred embodiment, the grip 280 comprises a plurality of ridges 285 defined by the exterior surface 205, extending between the open and closed ends 195 and 200, and spaced from one another by a common circumferal distance (CD). However, in other embodiments not illustrated herein, the grip comprises a plurality of outward stipples, crosshatches, or any other texture defined by the exterior surface and understood in the art of increasing a frictional contact between the sharpener and a user's hand.

In further embodiments of the sharpener 180, the closed end 200 defines a connector 290 configured for connection with a common lanyard (not illustrated). Referring to FIG. 18, the connector 290 preferably comprises an orifice 295 axially defined through the closed end 200 # of the casing 185 and a cross-bar 300 defined across the orifice. The cross-bar 300 serves as an attachment point around which the lanyard may be secured via a looping of the lanyard through itself and around the cross-bar.

While this foregoing description and accompanying figures are illustrative of the present invention, other variations in structure and method are possible without departing from the invention's spirit and scope.

We claim:

1. An improved marking utensil holder having a rigid hollow sleeve defining inner and outer surfaces and forward and rearward ends, the inner surface terminating in forward and rearward openings at the respective forward and rearward ends and configured to accept the insertion of a marking utensil there-through, said outer surface configured to be gripped in a user's hand, the forward end defining a collet to removably secure the utensil, said outer surface defining an outer engagement surface proximal to the rearward end, wherein the improvement comprises:
an axial hollow casing defining an interior surface between an open end and a closed end, and an exterior surface terminating at the open end and encompassing the closed end, the interior surface defining an interior engagement surface proximal to the open end for removable engagement with the outer engagement surface of the marking utensil holder, the open end configured to accept an insertion of the marking utensil therein and the closed end defining a segmented frusto conical socket defining a plurality of supports inwardly terminating in a plurality of frusto conical support surfaces and circumferally separated from one another by a through ejection port, each through ejection port terminating in an outer ejection opening defined within the outer surface and in an inner ejection opening defined circumferally between adjacent support surfaces, each ejection port defining a forward end of one support and a trailing end of a circumferally adjacent support;
a cutting edge co-planar with the forward end of each support, each cutting edge parallel with and extending inwardly from the support surface, each said cutting edge unitary with each said support and configured for cutting engagement with the marking utensil.

2. The improved marking utensil holder of claim 1 wherein the plurality of support surfaces defines an equally bisected segmented frusto conical socket.

3. The improved marking utensil holder of claim 1 wherein the plurality of support surfaces defines an equally tripartite segmented frusto conical socket.

4. The marking utensil sharpener of claim 3 wherein the cutting edge extends inwardly of the support surface by a distance of about 0.1 mm.

5. The improved marking utensil holder of claim 4 wherein the interior engagement surface defines a circumferal ridge.

6. The improved marking utensil holder of claim 4 wherein the interior engagement surface defines a circumferal furrow.

7. The improved marking utensil holder of claim 4 wherein the interior engagement surface defines a thread.

8. The improved marking utensil holder of claim 7 wherein the exterior surface defines a grip.

9. The improved marking utensil holder of claim 8 wherein the grip comprises a plurality of ridges extending between the open and closed ends.

10. The improved marking utensil of claim 9 wherein the closed end defines a connector configured for connection with a lanyard.

11. A marking utensil sharpener comprising:
an axial hollow casing defining an interior surface between an open end and a closed end, and an exterior surface terminating at the open end and encompassing the closed end, the interior surface defining an interior engagement surface proximal to the open end for removable engagement with an outer engagement surface of a marking utensil holder, the open end configured to accept an insertion of a marking utensil therein and the closed end defining a segmented frusto conical socket defining a plurality of supports inwardly terminating in a plurality of frusto conical support surfaces and circumferally separated from one another by a through ejection port, each through cjection port terminating in an outer ejection opening defined within the outer surface and in an inner ejection opening defined circumferally between adjacent support surfaces, each ejection port defining a forward end of one support and a trailing end of a circumferally adjacent support;
a cutting edge co-planar with the forward end of each support, each cutting edge parallel with and extending inwardly from the support surface, each said cutting edge unitary with each said support and configured for cutting engagement with the marking utensil.

12. The improved marking utensil holder of claim 11 wherein the plurality of support surfaces defines an equally bisected segmented frusto conical socket.

13. The improved marking utensil holder of claim 11 wherein the plurality of support surfaces defines an equally tripartite segmented frusto conical socket.

14. The marking utensil sharpener of claim 13 wherein the cutting edge extends inwardly of the support surface by a distance of about 0.1 mm.

15. The improved marking utensil holder of claim 13 wherein the interior engagement surface defines a circumferal ridge.

16. The improved marking utensil holder of claim 13 wherein the interior engagement surface defines a circumferal furrow.

17. The improved marking utensil holder of claim 13 wherein the interior engagement surface defines a thread.

18. The improved marking utensil holder of claim 17 wherein the exterior surface defines a grip.

19. The improved marking utensil holder of claim 18 wherein the grip comprises a plurality of ridges extending between the open and closed ends.

20. The improved marking utensil of claim 19 wherein the closed end defines a connector configured for connection with a lanyard.
